(19) United States
(12) Patent Application Publication
(10) Pub. No.: US 2025/0262026 A1
(43) Pub. Date: Aug. 21, 2025

(54) MULTIPLE COMPONENT DENTAL RESTORATION

(71) Applicant: James R. Glidewell Dental Ceramics, Inc., Newport Beach, CA (US)

(72) Inventors: James R. Glidewell, Newport Beach, CA (US); Sam Imsirovic, Newport Beach, CA (US); Wolfgang Friebauer, Costa Mesa, CA (US); Dongkyu Kim, Irvine, CA (US); Rajashekharam V. Malyala, Camarillo, CA (US)

(73) Assignee: James R. Glidewell Dental Ceramics, Inc., Newport Beach, CA (US)

(21) Appl. No.: 19/053,304

(22) Filed: Feb. 13, 2025

Related U.S. Application Data
(60) Provisional application No. 63/553,825, filed on Feb. 15, 2024.

(51) Int. Cl. A61C 5/77; A61C 13/00

(52) U.S. Cl. CPC A61C 5/77; A61C 13/0004

(57) ABSTRACT

A dental restoration includes multiple components including a coping, a veneer, and a fusing material that attaches the veneer to the coping. The coping and veneer components are separately designed to include mating positive and negative relief regions, and the coping and veneer are formed of materials that provide esthetic properties that mimic natural teeth.

This application claims the benefit of and priority to U.S. Provisional Patent Application No. 63/553,825, filed Feb. 15, 2024, which is incorporated herein by reference in its entirety.

### BACKGROUND

Restorative dentistry is concerned with repairing or replacing damaged or missing teeth. Dental restorations are designed and manufactured to restore the function of the damaged or missing teeth. In addition to function, the appearance or esthetic value of dental restorations is an important consideration for clinicians and patients. Restoration esthetics are particularly important for dental restorations in the anterior dentition zone, which includes the cuspids, incisors, lateral incisors, and the beginning of the buccal corridor.

As shown in FIGS. 1A-1C, a conventional anterior dental restoration (100), such as a crown, may have an incisal surface (101) that comes into contact with opposing teeth during occlusion. A fitting surface or cavity (102) fits on an abutment or a preparation tooth, a patient's tooth which outer surface has been prepared, e.g., by removing a portion of the natural tooth. A gingival margin (103) comprises a region or edge between the fitting surface and a vestibular surface. The vestibular surface (104) comprises the outer surface of the restoration including a labial surface (105) that faces the lips of a patient, and a lingual surface (106) facing the tongue. Vestibular side surfaces (107), include a mesial surface that is the side of the crown closest the midline of the patient's mandible or maxilla and a distal surface that is the side of the tooth farthest from the midline, both of which may be proximal contact surfaces to adjacent teeth when installed in the mouth of a patient.

Natural human teeth present up to three internal dentin lobes on the facial aspect that finish close to the incisal edge. The internal dentin lobes are covered with translucent enamel all over the anatomical part of the crown and terminate in mamelons on the incisal edge.

Conventional restorative dentistry materials and techniques are unable to satisfactorily reproduce many of the anatomical features of natural teeth. Ceramic and glass-ceramic materials provide excellent physical properties for tooth function. Layered structures of these materials have also been used to attempt to take advantage of a framework made from a strong material (e.g., zirconia) with one or more layers of a more esthetic material (e.g., porcelain or glass-ceramic) applied over the framework. But restorations made from these improved materials and layering techniques can appear too opaque, and fail to provide features that mimic the anatomic structures observable in natural teeth.

It is therefore a continued objective to provide dental restorations that are functional (e.g., strong and tough) and that provide improved esthetics such that the dental restorations appear more like natural human teeth.

### SUMMARY

The present disclosure provides for a dental restoration that includes multiple components including a coping, a veneer, and a fusing material that attaches the veneer to the coping. The coping and veneer components are separately designed to include mating positive and negative relief regions, and the coping and veneer are formed of materials that provide esthetic properties that mimic natural teeth.

Certain disclosed aspects concern a dental restoration for installation on a prepared tooth of a dental patient, the dental restoration comprising: (1) a coping formed of a first material having a first flexural strength and a first transmittance, wherein the coping includes an inner concave surface shaped to accommodate the prepared tooth, and an outer surface having at least one labial lobe and a plurality of peaks and valleys formed toward an incisal edge; (2) a veneer formed of a second material having a second flexural strength and a second transmittance, wherein the veneer includes an inner surface shaped to accommodate the coping, including an inner surface that matches the outer surface of the coping to define a substantially uniform gap between the veneer inner surface and the coping outer surface when the veneer is placed over the coping; and (3) a fusing material interposed between the coping and the veneer within the substantially uniform gap.

In some embodiments of the dental restoration, each of the first material and the second material is a stabilized zirconia material, such as an yttria stabilized zirconia ceramic material. In some additional embodiments, the second material is a stabilized zirconia material, such as an yttria stabilized zirconia ceramic material, stabilized by 5 mol % to 7.2 mol % yttria, wherein the ceramic material formed as a sintered ceramic body has a flexural strength greater than 500 MPa, and a transmittance greater than 62% at 700 nm (when measured on a 1 mm thick fully sintered ceramic body). In still other embodiments, the second material when formed as a sintered body has a fracture toughness greater than 1.5 MPa·m^{-1/2}. In still other embodiments, the second material when formed as a sintered body has an average grain size between 1 and 20 μm.

In some embodiments of the dental restoration, the first material is a stabilized zirconia material, such as an yttria stabilized zirconia material, stabilized by 3 mol % to 7.2 mol % yttria. In some additional embodiments, the first material is a stabilized zirconia material, such as an yttria stabilized zirconia ceramic material, stabilized by 4 mol % to 5.1 mol % yttria, wherein the zirconia ceramic material formed as a sintered ceramic body has a flexural strength of at least 800 MPa and a transmittance of at least 55% at 700 nm (when measured on a 1 mm thick fully sintered ceramic body). In still other embodiments, the first material is a stabilized zirconia material, such as an yttria stabilized zirconia ceramic material, stabilized by 3.9 mol % to 5.0 mol % yttria, wherein the zirconia ceramic material formed as a sintered ceramic body has a flexural strength of at least 800 MPa, and a ΔT from −2.5 to 0.5 at 700 nm (when measured on a 1 mm thick fully sintered ceramic body).

In some embodiments of the dental restoration, the fusing material comprises a glass material. In other embodiments, the fusing material comprises a glass material having a fusing temperature of between 680° C. to 880° C. In still other embodiments, the fusing material comprises a glass material having a fusing temperature of between 880° C. to 1150° C. In still other embodiments, the fusing material comprises a dental cement (e.g., light cured, chemical cured, or dual-cured). In still other embodiments, the fusing material comprises a dental bonding material, such as a radiation curable dental bonding material.

In some embodiments of the dental restoration, the first flexural strength is greater than the second flexural strength. In other embodiments, the first transmittance is less than the second transmittance.

Also disclosed herein is a method of making a dental restoration to be installed on a prepared tooth of a dental patient. In some aspects, the method comprises: (1) obtaining a virtual model of dentition of the dental patient, the virtual model including a model of the prepared tooth; (2) using the virtual model to design the dental restoration, wherein the dental restoration includes a coping and a veneer, and wherein the coping includes an inner concave surface shaped to accommodate the prepared tooth, and an outer surface having at least one facial lobe and a plurality of peaks and valleys formed on an incisal edge, and wherein the veneer includes an inner surface shaped to accommodate the coping, including an inner surface that matches the outer surface of the coping to define a substantially uniform gap between the veneer inner surface and the coping outer surface when the veneer is placed over the coping; (3) fabricating the coping; (4) fabricating the veneer; and (5) attaching the coping to the veneer using a fusing material. In some embodiments, the coping and the veneer are fabricated using separate manufacturing processes.

In some embodiments of the method of making a dental restoration, the coping is fabricated using a subtractive manufacturing process, such as by milling the coping from a blank of material. In some embodiments, the milling process includes a tool radius compensation. In some embodiments, the coping is fabricated by milling the coping from a blank of zirconia material, such as by milling the coping from a blank of sintered zirconia material.

In some embodiments of the method of making a dental restoration, the veneer is fabricated using a subtractive manufacturing process, such as by milling the veneer from a blank of material. In some embodiments, the milling process includes a tool radius compensation. In some embodiments, the veneer is fabricated by milling the veneer from a blank of zirconia material, such as by milling the veneer from a blank of sintered zirconia material.

In some embodiments, one or both of the coping and the veneer is fabricated using an additive manufacturing process, such as a 3D printing process.

In some embodiments, one or both of the coping and the veneer is fabricated using a casting process, such as a lost wax casting process.

In some embodiments, one or both of the coping and the veneer is formed of a glass ceramic material.

In some embodiments, the fusing material is a mixture of a glass powder and liquid having a solids content of from 60% to 75%.

In some embodiments of the method of making a dental restoration, the assembled coping, veneer, and fusing material is heat treated at a temperature of from 900° C. to 1300° C. for a hold time of from 5 minutes to 90 minutes. In some embodiments, the assembled coping, veneer, and fusing material is pressure treated at a pressure of from 20 psi to 65 psi for a hold time of 3 to 60 minutes prior to the heat treatment. In some embodiments, a vacuum is applied during at least a portion of the heat treatment.

The foregoing and will become more apparent from the following detailed description, which proceeds with reference to the accompanying figures.

### BRIEF DESCRIPTION OF THE DRAWINGS

FIGS. 1A-1C are graphic representations of a conventional anterior dental restoration.

FIG. 2A is a coping component of a multiple component dental restoration.

FIG. 2B is a cross-section of the coping shown in FIG. 2A, taken at line 2B 2B.

FIG. 3A is a veneer component of a multiple component dental restoration.

FIG. 3B is a cross-section of the veneer shown in FIG. 3A, taken at line 3B 3B.

FIG. 4A is a multiple component dental restoration.

FIG. 4B is a cross-section of the dental restoration shown in FIG. 4A, taken at line 4B-4B.

FIG. 5 is a flowchart showing a process for designing and manufacturing a multiple component dental restoration.

FIGS. 6A-E are graphic representations of an alternative embodiment of a method for combining a coping component and veneer component into a single unit.

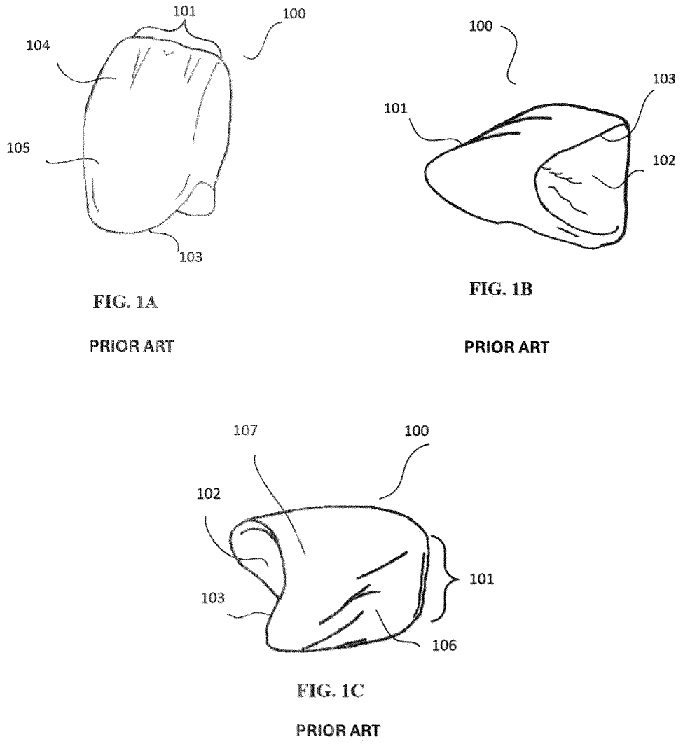

While the above-identified drawings set forth presently disclosed embodiments, other embodiments are also contemplated, as noted in the detailed description. This disclosure presents illustrative embodiments by way of representation and not limitation. Numerous other modifications and embodiments can be devised by those skilled in the art which fall within the scope and spirit of the principles of the present disclosure.

### DETAILED DESCRIPTION

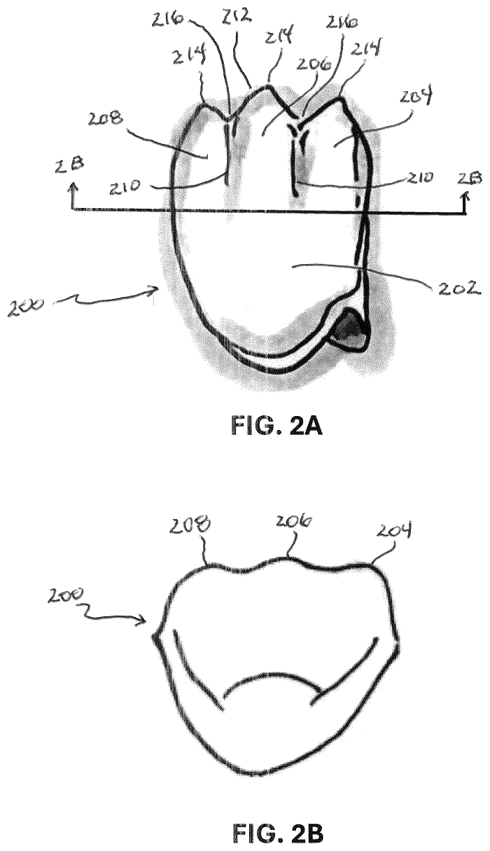

Multiple component dental restorations and methods for making multiple unit dental restorations are described herein. Turning to FIGS. 2A-2B, 3A-3B, and 4A-4B, in an embodiment, a multiple component anterior dental restoration (400) is provided that comprises a coping component (200) formed of a strong and tough first material, a veneer component (300) formed of a strong, highly translucent second material, and a fusing material (410) interposed in a substantially uniform gap (402) separating the coping and veneer components. In an embodiment, a method for manufacturing the multiple component dental restoration includes designing the individual components, fabricating the coping component and veneer component separately, and fusing the coping component to the veneer component using the fusing material. The improved dental restoration and method for manufacturing are described more fully herein.

The multiple component dental restoration (400) shown in the above-identified figures is in the form of an anterior crown. As noted above, this disclosure presents illustrative embodiments by way of representation and not limitation. Other embodiments of multiple component dental restorations are also possible, including single, or splinted, or multiple unit bridges, or implant crowns, or implant bridges, or full arch restorations. Numerous other modifications and embodiments can be devised by those skilled in the art which fall within the scope and spirit of the principles of the present disclosure.

### Coping Structures, Materials, and Fabrication

Turning to FIGS. 2A-2B, in the multiple component dental restoration described herein, the coping component (200) is preferably formed of a material having high flexural strength, high fracture toughness, and having a color/shade and translucency that is comparable to the dentin region of a natural human tooth when covered by the veneer component.

In some embodiments, the coping component (200) is formed of a ceramic material, such as an yttria-stabilized zirconia material. For example, U.S. Pat. No. 9,309,157 (Tosoh Corporation), which is hereby incorporated by reference, describes zirconia sintered bodies for use in dental applications that are formed from zirconia powder containing 2-4 mol % yttria as a stabilizer, and having reported three-point bending strength of 1,000 MPa or higher.

In some embodiments, the coping component (200) is formed of an yttria-stabilized zirconia material such as those described in U.S. Pat. No. 10,532,008 (Glidewell Laboratories), which is also hereby incorporated by reference. The '008 patent describes zirconia sintered bodies for use in dental applications that contain yttria-stabilized zirconia having a flexural strength of at least 800 MPa, such as between 800 MPa and 1050 MPa, and a total light transmittance value of at least 52%, such as between 52% and 60%, to light having a wavelength of 700 nm. In some embodiments, the zirconia sintered body includes yttrium oxide at a concentration of between 4.0 mol % and 5.3 mol %.

In some other embodiments, the coping component (200) is formed of a glass material, a glass-ceramic material, or a ceramic material. For example, U.S. Pat. No. 7,892,995 (Glidewell Laboratories), which is hereby incorporated by reference, describes lithium silicate materials for use in dental applications having a flexural strength of greater than 300 MPa. The lithium silicate materials described in the '995 patent may be formed into a suitable coping component (200) using conventional pressing/casting or CAD/CAM techniques known to those skilled in the art. Similarly, lithium disilicate materials such as IPS e.max® (Ivoclar Vivadent) may be formed into a suitable coping component (200) using conventional pressing/casting or CAD/CAM techniques known to those skilled in the art.

In some embodiments, the coping component (200) is formed having a shape that provides contours that mimic the appearance of a natural human tooth. For example, in the embodiment shown in FIGS. 2A-2B, the coping component (200) includes a plurality of labial lobes separated by labial depressions that provide an appearance that mimics a natural human anterior tooth. As shown, the labial surface (202) of the coping component (200) includes a distal labial lobe (204), a middle labial lobe (206), and a mesial labial lobe (208). The labial lobes comprise raised regions separated by labial depressions (210) on the labial surface (202) of the coping component (200). An incisal edge (212) is shaped to have a jagged appearance that includes three peaks (214) formed at the terminal ends of the labial lobes (204, 206, 208) and two valleys (216) formed at the terminal ends of the labial depressions (210).

### Veneer Structures, Materials, and Fabrication

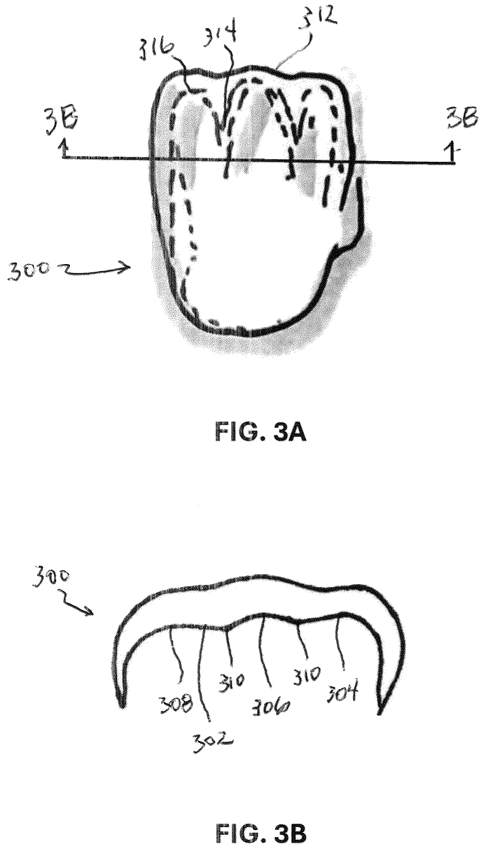

Turning to FIGS. 3A-3B, in the multiple component dental restoration described herein, the veneer component (300) is preferably formed of a material having high flexural strength, high fracture toughness, and having a color/shade and translucency that is comparable to the enamel region of a natural human tooth when the veneer component covers the coping component.

In some embodiments, the veneer component (300) is formed of a glass material, a glass-ceramic material, or a ceramic material. For example, U.S. Pat. No. 7,892,995 (Glidewell Laboratories), which is hereby incorporated by reference, describes lithium silicate materials for use in dental applications having a flexural strength of greater than 300 MPa. The lithium silicate materials described in the '995 patent may be formed into a suitable veneer component (300) using conventional pressing/casting or CAD/CAM techniques known to those skilled in the art. Similarly, lithium disilicate materials such as IPS e.max® (Ivoclar Vivadent) may be formed into a suitable veneer component (300) using conventional pressing/casting or CAD/CAM techniques known to those skilled in the art.

In some embodiments, the veneer component (300) is formed of a dental composite material. Conventional dental composite materials comprise a resin-based oligomer matrix and an inorganic filler (typically glass and/or ceramic). An example of a suitable dental composite material is Camouflage® NOW milling blocks (Glidewell Laboratories).

In some embodiments, the veneer component (300) is formed of an yttria-stabilized zirconia material such as those described in U.S. Pat. No. 11,161,789, which is hereby incorporated by reference. The '789 patent describes zirconia sintered bodies for use in dental applications that contain yttria-stabilized zirconia stabilized by 5 mol % to 7.2 mol % yttria, wherein the ceramic material formed as a sintered ceramic body has a flexural strength greater than 500 MPa, and a transmittance greater than 62% at 700 nm (when measured on a 1 mm thick fully sintered ceramic body). In some embodiments, the sintered zirconia material has a fracture toughness greater than 1.5 MPa·m^{-1/2}, and an average grain size between 1 and 20 μm.

In some embodiments, the veneer component (300) is formed having a shape that provides contours that mimic the appearance of a natural human tooth when the veneer component (300) is combined with the coping component (200). For example, in the embodiment shown in FIGS. 3A-3B, the veneer component (300) includes a plurality of internal surface concave regions separated by peaks that mirror the labial lobes and labial depressions formed on the coping component, and that provide an appearance that mimics a natural human anterior tooth. As shown, the internal surface (302) of the veneer component (300) includes a distal internal concavity (304), a middle internal concavity (306), and a mesial internal concavity (308). The internal concavities comprise depressed regions separated by internal surface peaks (310) on the internal surface (302) of the veneer component (300). An incisal edge (312) is shaped to have a jagged appearance that includes three peaks (314) formed at the terminal ends of the internal concavities (304, 306, 308) and two valleys (316) formed at the terminal ends of the internal surface (310).

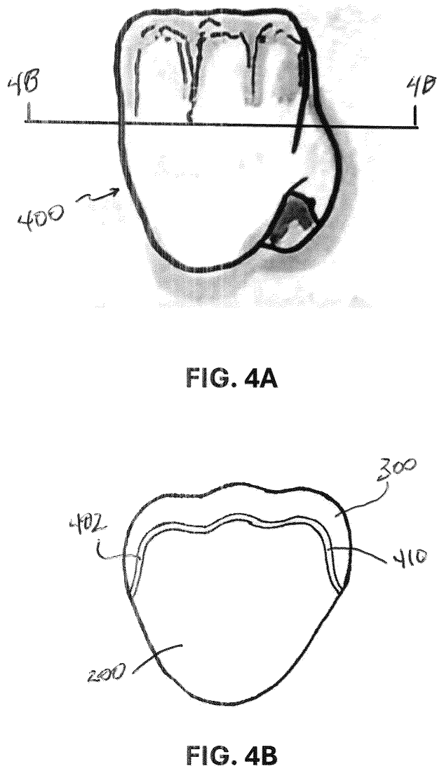

The veneer component (300) in the embodiments shown in FIGS. 3A-3B covers the facial and side surfaces of the coping component (200), as also shown in FIGS. 4A-4B. In other embodiments, the veneer component (300) may be provided with a lingual side that provides full coverage of the coping component (200).

### Fusing Material

In the embodiment shown in FIGS. 4A-4B, the multiple component dental restoration (400) includes a substantially uniform gap (402) that is defined by a space separating the coping component (200) and the veneer component (300) when they are brought into opposition. In some embodiments, the width of the substantially uniform gap is appropriate to provide a sliding fit between the coping component (200) and the veneer component (300). In some embodiments, the width of the substantially uniform gap (402) is from 30 μm to 150 μm, such as from 30 μm to 100 μm, or from 30 μm to 50 μm. The width of the substantially uniform gap (402) is able to be controlled during the restoration design process described herein.

The term “substantially uniform” as used herein to refer to the “substantially uniform gap” describes a gap that has a substantially uniform width throughout the volume of the space separating the coping component (200) and the veneer component (300) when they are brought into opposition. The width of the gap may vary due to design or manufacturing tolerances and other limitations (e.g., there may be locations where the gap narrows or widens, or where the components are in contact), but the width of the gap is generally uniform throughout the majority of the volume.

In some embodiments, a fusing material (410) is placed in the substantially uniform gap (402) and serves the purpose of attaching or fusing the coping component (200) to the veneer component (300). In some embodiments, the fusing material (410) may comprise a low temperature (e.g., 680° C.-880° C.) glass material comprising colorless or tooth shade colored glass powders similar to glazing and finishing powders for dental glass ceramic dental restorations. An example of these materials is CGI Glaze, CeraGroup Industries, Ft. Lauderdale, Florida. In other embodiments, the fusing material (410) may comprise a high temperature (e.g., 880° C.-1150° C.) glass material comprising colorless or tooth shade colored glass powders similar to glaze and glass solder connecting applications on glass ceramic and ceramic base structures. An example of these materials is DCMhotbond Zircon, Dental Creativ Management GmbH, Rostock, Germany. In other embodiment, the fusing material (410) may comprise a dental cement, adhesive, or bonding material (e.g., chemical curable, light curable, or dual curable). An example of these materials is Variolink Esthetic LC, Ivoclar, Liechtenstein.

Silicate-based glass solders are available to bond ceramics and provide biocompatibility and high bonding strength. Glass solders are known to those skilled in the art, and include oxide powders such as, but not limited to, SiO₂, Al₂O₃, K₂O, Na₂O, SrO, ZnO, SnO₂, CeO₂, La₂O₃, and B₂O₃. In some embodiments, a glass solder powder is blended with a liquid to create a paste suitable for use as a fusing material. In a representative method, the glass solder paste is applied in the substantially uniform gap (410) between the coping component (200) and the veneer component (300), and the combination is placed in a furnace and heated to the fusing temperature of the glass solder material (e.g., 680° C. to 880° C., or 880° C. to 1150° C.).

Dental cements are also known to those skilled in the art, including glass ionomer cements, resin-modified glass ionomer cements, resin cements, and others. In some embodiments, the dental cement is either light-cured, chemical cured, or dual cured.

### Restoration Design and Manufacturing

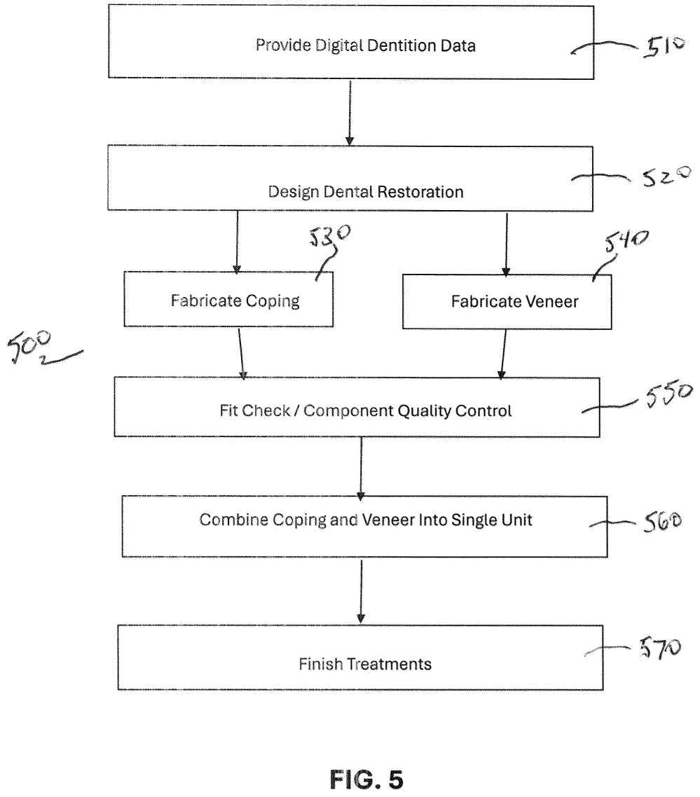

With reference to FIG. 5, an exemplary embodiment of a method for designing and manufacturing dental restorations is provided. In the embodiment shown, the method includes providing dentition data of the patient in a digital format (510). The dentition data is then used to design a virtual model of a digital restoration (520), the virtual model including separate models corresponding to a coping component and a veneer component. The virtual model is then used to fabricate a physical coping component (530) and to fabricate a physical veneer component (540). The coping component and veneer component are fabricated as separate components. After the physical coping component and veneer component have been fabricated, they are each subjected to a fit check and quality control process (550). The coping component and veneer component are then combined into a single dental restoration at step (560). The dental restoration then undergoes finish treatments at step (570).

Further details of the foregoing methods steps are described more fully herein.

### Provide Digital Dentition Data (510)

The computer-implemented methods of designing dental restorations described herein use an electronic image of at least a portion of a patient's oral situation as a starting point for the design process. Using the electronic image, a computer-implemented dental restoration design system is used to design a suitable dental restoration and to provide instructions to a restoration fabrication system. The fabrication system is then used to produce the dental restoration, which may then be installed into the patient's mouth by the dentist.

An initial step for the computer-implemented methods described herein is to provide an electronic image of at least a portion of the patient's oral situation. In some embodiments, the electronic image is obtained by a direct intraoral scan of the patient's teeth. This will typically take place, for example, in a dental office or clinic and be performed by a dentist or dental technician. In other embodiments, the electronic image is obtained indirectly by scanning an impression of the patient's teeth, by scanning a physical model of the patient's teeth, or by other methods known to those skilled in the art. This will typically take place, for example, in a dental laboratory and be performed by a laboratory technician. Accordingly, the methods described herein are suitable and applicable for use in chairside, dental laboratory, or other environments.

In a laboratory environment, an electronic image is typically obtained by scanning a physical impression taken of the patient's teeth, or by scanning a physical model of the patient's teeth that has been prepared, for example, from a physical impression. Details of these processes are beyond the scope of the present description and will be understood by those skilled in the art of dental restoration design and manufacturing.

For chairside applications, there are several systems and methods for acquiring electronic image information from a patient. A typical system includes an intra-oral scanning system. There are several intraoral imaging technologies and products that are currently available, including fastscan.io™ (Glidewell Laboratories), i700® (Medit), Trios® (3Shape), and iTero™ (Cadent/Align Technology, Inc.). Once the scanning process is completed, the scanning system will assemble the plurality of scans into a digital model of the preparation tooth and its surrounding and opposing teeth.

### Design Dental Restoration (520)

Dental CAD/CAM software is used to create a 3D digital model of a dental restoration and then instruct a restoration fabrication system on how to produce it. Dental CAD (computer-aided design) software is designed to guide the technician through designing a 3D digital model of a restoration. Dental CAM (computer-aided manufacturing) software then applies the CAD design to a manufacturing system and manufactures the dental restoration.

In an embodiment, the dental CAD software is used to design a multiple component dental restoration that includes a coping component, a veneer component, and a fusing material space. The dental CAD software may be provided with a split file functionality whereby the coping and veneer component files are automatically separated (or separated at the initiation of the user) in order to separately design the coping and veneer components.

The dental CAD software may be adapted to several different manufacturing methods, as described herein. In an embodiment, the dental CAD software provides an output file used to manufacture a part using a subtractive manufacturing method, such as milling or machining. In some embodiments, the milling instructions incorporate tool radius compensation to provide a way to accommodate the radius of the nose of the tool used to perform the milling process.

### Fabricate Coping (530) and Fabricate Veneer (540)

In the manufacturing methods described herein, the coping component (200) and veneer component (300) of the multiple component dental restoration (400) are fabricated as separate components. Accordingly, each component may be fabricated using the same, or different systems and methods.

Three categories used to describe manufacturing methods in dentistry are “subtractive,” “additive,” and “indirect” manufacturing methods. Subtractive manufacturing methods remove material to create parts, and include machining and milling and laser ablation technologies. Additive manufacturing methods build objects by adding material layer by layer, and include 3D printing and laser melting technologies. Indirect manufacturing methods include casting (e.g., lost wax) and molding (e.g., injection molding) technologies. Each of these methods is well known in the art, and a full description of them is beyond the scope of this disclosure.

In an embodiment, each of the coping component (200) and the veneer component (300) comprises a zirconia material, and each is fabricated using a milling process.

In some embodiments, one or both of the coping component (200) and veneer component (300) are designed and manufactured to include a surface texture added to the external surface of the coping component (200) and/or the internal surface of the veneer component (300). The surface texture may be provided by adding internal lines, ridges, furrows, and/or grooves on these mating surfaces to obtain an undulating surface that thereby increases the surface area and provides greater bond strength between the coping component (200) and veneer component (300) after the components are combined and fused together with the fusing material (410).

### Fit Check/Component Quality Control (550)

In some embodiments, one or both of the coping component (200) and the veneer component (300) undergoes a fit check to confirm that the component has a functionally acceptable size, shape, and construction. The fit check may be performed using a physical model, or the components may be scanned and compared to a virtual model.

In some embodiments, one or both of the coping component (200) and the veneer component (300) undergoes a quality control inspection to confirm that the component meets design parameters within an acceptable tolerance. The quality control inspection may be performed manually by a clinician, or the quality control inspection may be performed automatically using machine vision technologies known to those skilled in the art.

### Combine Coping and Veneer Into Single Unit (560)

After the coping component (200) and veneer component (300) have been fabricated as separate parts, they can be combined into a single unit as a multiple component dental restoration (400). In an embodiment, a fusing material (410) is placed on the outer surface of the coping component (200) and/or on the inner surface of the veneer component (300). The veneer component (300) is then placed on or over the coping component (200). The combination is then subjected to an appropriate treatment (e.g., light cure, chemical cure, and/or heat treatment) to cause the fusing material (410) to fuse the coping component (200) and veneer component (300) together.

In those embodiments that include oven or heat treatments for fusing components together or surface finishing (e.g., glazing) components or the restoration as a whole, the oven or heat treatments are performed in an appropriate manner and order to achieve the desired result. For example, for fusing procedures that are performed at room temperature, any high temperature procedures to be performed on the individual coping component (200) or veneer component (300) should be performed prior to the fusing procedure.

In some embodiments, a coping component (200) formed of a zirconia material is fused to a veneer component (300) also formed of a zirconia material. A fusing material (410) is provided by mixing a glass powder (CGI Universal Glaze Powder, Ceragroup Industries) with a ceramic powder mixing liquid (Glaze & Stain Medium, American Dental Supply) to an optimal viscosity for application to the coping component (200) and/or veneer component (300). The powder and liquid mixture has a solids content of from about 60 wt % to about 75 wt %, or from about 65 wt % to about 75 wt %, or from about 68 wt % to about 75 wt %. The fusing material (410) is applied to the external surface of the coping component (200), the internal surface of the veneer component (300), or both, after which the coping component (200) and veneer component (300) are brought together.

After the coping component (200) and veneer component (300) are combined together with the fusing material (410), the resulting combination undergoes a heat treatment to solid melt-bond the components together. In some embodiments, the heat treatment includes heating the combination of components to a temperature of from 900° C. to about 1300° C. for a hold time of 5 minutes to 90 minutes, such as from 900° C. to about 1100° C. for a hold time of 30 minutes to 90 minutes, such as from 950° C. to about 1050° C. for a hold time of 45 minutes to 75 minutes. In some embodiments, pressure and/or vacuum treatments are used in combination with the heat treatment. As an example, in some embodiments, after combining the coping component (200) with the veneer component (300) using the fusing material (410), the combination is placed in a pressure chamber (BEGO Pressure, Rhode Island) and is subjected to a pressure treatment of 20 to 65 psi for a holding time of from 3 to 60 minutes. In some embodiments, a vacuum is applied during all or a portion of the heat treatment cycle. For example, a heat treatment cycle may include application of vacuum after the heat treatment has reached a temperature of 350° C., or after reaching a temperature of 600° C., or after reaching a temperature of 800° C. and is maintained for the remainder of the heat treatment.

### Alternative Combine Coping and Veneer Into Single Unit (560′)

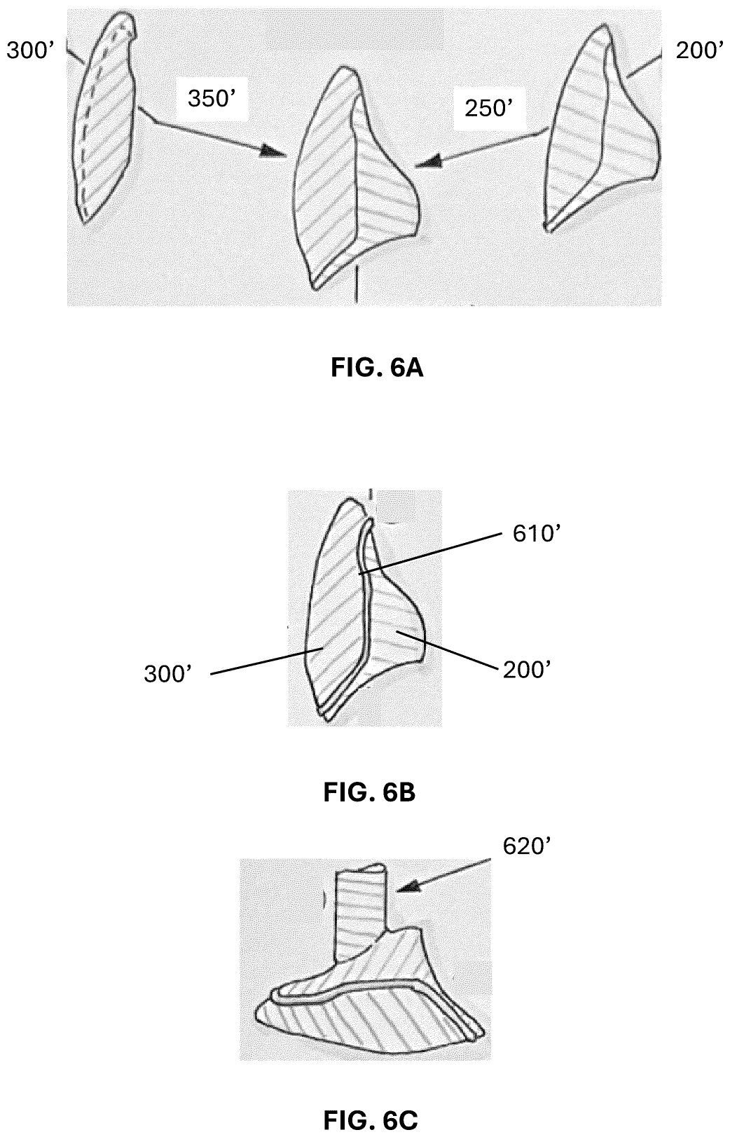

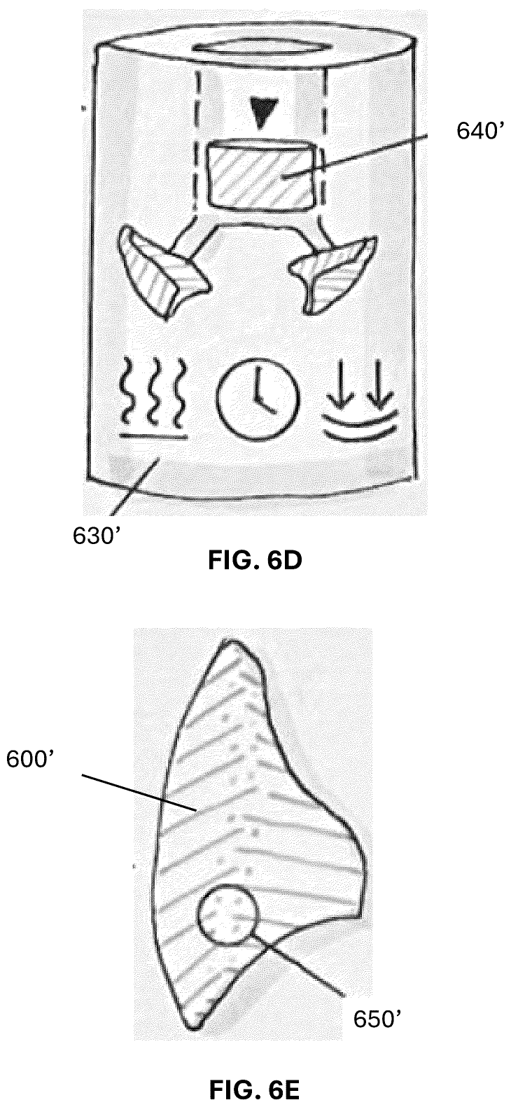

In an embodiment illustrated in FIGS. 6A-E, an alternative method for combining a coping component (200′) with a veneer component (300′) is described. The alternative embodiment is suitable for combining components formed of glass ceramic materials, including lithium silicate and lithium disilicate, and does not require a separate fusing material. After the coping component (200′) and veneer component (300′) have been fabricated as separate parts, they can be combined into a single unit as a multiple component dental restoration (600′).

As shown in FIG. 6A, a coping component (200′) and a veneer component (300′) are formed from glass ceramic materials (e.g., lithium silicate, lithium disilicate). Preferably, the veneer component (300′) is formed of a material having higher translucency than the material of the coping component (200′). The individual components may be formed using conventional milling, pressing or other fabrication methods known to those skilled in the art. The components are designed and fabricated such that they have mating surfaces that are in close engagement to each other when the components are brought into contact as shown by the arrows (250′, 350′) in FIG. 6A.

As shown in FIGS. 6B-C, prior to placing the components into a dental ceramic furnace (630′), a thin layer (610′) of a wax or polymer burnout material is placed to seal the outer mating line of the coping component (200′) and veneer component (300′). In addition, a sprue (620′) of the wax or polymer burnout material is also formed on the back side of the coping component. After these preparations are made, the components are coated with a slurry of investment material that is cast into a mold, and the wax or polymer material is burned out. An ingot (630′) of the same material used to form the coping component (200′) is then heated and pressed into the mold retained in the dental ceramic furnace (630′). The heat, pressure, and time are selected such that the coping component (200′) and veneer component (300′) surpass their glass transition temperatures (Tg), thereby causing the components to fuse together over their mating surfaces. After the heat treatment is complete, the resulting dental restoration (600′) is divested from the mold and the sprue removed and the restoration cleaned. In this alternative embodiment, no fusing material is used, and there is therefore no resultant fusing layer at the interface (650′) between the components.

### Restoration Finishing Treatments (570)

Several finishing treatments for conventional dental restorations are suitable and appropriate for the multiple component dental restorations described herein. In some embodiments, the veneer component is formed of a zirconia material that may be optionally finished with one or more of a staining process, a glazing process, and/or a polishing process. As noted above, in the case of using a room/low temperature bonding cement, the component parts should be temperature glazed prior to the bonding procedure, or the completed dental restoration can be conventionally polished after the bonding procedure.

In some embodiments, the manufacturing process described herein includes designing and manufacturing a coping component (200) and veneer component (300) as separate components that are then combined using a fusing material (410). In those embodiments, there is the opportunity to provide individualized or customized staining and coloring of the external surface of the coping component (200) and/or the internal surface of the veneer component (300) prior to their combination. These stain and coloring treatments provide a natural appearance as they are applied to an internal surface of the finished restoration, as compared to conventional staining onto the outer surface of a ceramic restoration.

In an embodiment, after completed fusing of the coping component (200) and veneer component (300), any excess glass or adhesive material is removed and the fused restoration (400) is cleaned. Then, a one or two step seal and glaze process is undertaken. In a first step, a brush or a similar tool is used to apply a glaze paste along the borderline between the mating coping component (200) and veneer component (300). This application of glaze paste is intended act as a sealing step to assure that there are no open voids, crevices, border steps, irregular heights, and mating differences between the components. After firing is completed in a furnace (720° C. to 950° C.) and the restoration (400) is cooled, the surface between the two components will be smooth and ready to receive a final glaze finish. In a second step, a spray gun, brush, or similar tool is used to apply a glaze media over the full outer surface of the restoration (400). After firing is completed in a furnace (720° C. to 980° C.) the outer surface of the restoration (400) is in final form and ready for final inspection and quality control. In some embodiments, only the second step is performed.

In view of the many possible embodiments to which the principles of the disclosed invention may be applied, it should be recognized that the illustrated embodiments are only preferred examples of the invention and should not be taken as limiting the scope of the invention.

What is claimed is:

1. A dental restoration for installation on a prepared tooth of a dental patient, the dental restoration comprising:
a coping formed of a first material having a first flexural strength and a first transmittance, wherein the coping includes an inner concave surface shaped to accommodate the prepared tooth, and an outer surface having at least one labial lobe and a plurality of peaks and valleys formed toward an incisal edge;
a veneer formed of a second material having a second flexural strength and a second transmittance, wherein the veneer includes an inner surface shaped to accommodate the coping, including an inner surface that matches the outer surface of the coping to define a substantially uniform gap between the veneer inner surface and the coping outer surface when the veneer is placed over the coping; and
a fusing material interposed between the coping and the veneer within the substantially uniform gap.

2. The dental restoration of claim 1, wherein each of the first material and the second material is an yttria stabilized zirconia ceramic material.

3. The dental restoration of claim 1, wherein the second material is an yttria stabilized zirconia ceramic material, stabilized by 5 mol % to 7.2 mol % yttria, wherein the ceramic material formed as a sintered ceramic body has a flexural strength greater than 500 MPa, and a transmittance greater than 62% at 700 nm (when measured on a 1 mm thick fully sintered ceramic body).

4. The dental restoration of claim 1, wherein the first material is an yttria stabilized zirconia material, stabilized by 3 mol % to 7.2 mol % yttria.

5. The dental restoration of claim 1, wherein the first material is an yttria stabilized zirconia ceramic material, stabilized by 4 mol % to 5.1 mol % yttria, wherein the zirconia ceramic material formed as a sintered ceramic body has a flexural strength of at least 800 MPa and a transmittance of at least 55% at 700 nm (when measured on a 1 mm thick fully sintered ceramic body).

6. The dental restoration of claim 1, wherein the fusing material comprises a glass material having a fusing temperature of between 680° C. to 880° C.

7. The dental restoration of claim 1, wherein the fusing material comprises a glass material having a fusing temperature of between 880° C. to 1150° C.

8. The dental restoration of claim 1, wherein the fusing material comprises a dental cement.

9. The dental restoration of claim 1, wherein the fusing material comprises a dental bonding material.

10. The dental restoration of claim 1, wherein the first flexural strength is greater than the second flexural strength, and the first transmittance is less than the second transmittance.

11. A method of making a dental restoration to be installed on a prepared tooth of a dental patient, the method comprising:
obtaining a virtual model of dentition of the dental patient, the virtual model including a model of the prepared tooth;
using the virtual model to design the dental restoration, wherein the dental restoration includes a coping and a veneer, and wherein the coping includes an inner concave surface shaped to accommodate the prepared tooth, and an outer surface having at least one facial lobe and a plurality of peaks and valleys formed toward an incisal edge, and wherein the veneer includes an inner surface shaped to accommodate the coping, including an inner surface that matches the outer surface of the coping to define a substantially uniform gap between the veneer inner surface and the coping outer surface when the veneer is placed over the coping;
fabricating the coping;
fabricating the veneer;
attaching the coping to the veneer using a fusing material.

12. The method of making a dental restoration of claim 11, wherein the coping is fabricated by milling the coping from a blank of material.

13. The method of making a dental restoration of claim 12, wherein the milling process includes a tool radius compensation.

14. The method of making a dental restoration of claim 11, wherein the coping is fabricated by milling the coping from a blank of zirconia material.

15. The method of making a dental restoration of claim 11, wherein the veneer is fabricated by milling from a blank of material.

16. The method of making a dental restoration of claim 15, wherein the milling process includes a tool radius compensation.

17. The method of making a dental restoration of claim 11, wherein the veneer is fabricated by milling from a blank of zirconia material.

18. The method of making a dental restoration of claim 11, wherein the coping and the veneer are fabricated using separate manufacturing processes.

19. The method of making a dental restoration of claim 11, further comprising:
heat treating the assembled coping, veneer, and fusing material at a temperature of from 900° C. to 1300° C. for a hold time of from 5 minutes to 90 minutes, and
wherein the fusing material is a mixture of a glass powder and liquid having a solids content of from 60% to 75%.

20. The method of making a dental restoration of claim 19, further comprising:
prior to the heat treating step, pressure treating the assembled coping, veneer, and fusing material at a pressure of from 20 psi to 65 psi for a hold time of 3 to 60 minutes.

21. The method of making a dental restoration of claim 19, further comprising:
applying a vacuum during at least a portion of the heat treating step.
